(19) United States
(12) Patent Application Publication
(10) Pub. No.: US 2015/0268368 A1
(43) Pub. Date: Sep. 24, 2015

(54) METHOD AND SYSTEM FOR CONTROLLING GEO-PHYSICAL SCANNERS

(71) Applicant: King Abdul Aziz City for Science and Technology (KACST), Riyadh (SA)

(72) Inventors: Fouzan Ali Alfouzan, Riyadh (SA); Mazen M. Alyousif, Riyadh (SA); Khaled Mahmoud Bakkour, Riyadh (SA)

(73) Assignee: King Abdul Aziz City for Science and Technology (KACST), Riyadh (SA)

(21) Appl. No.: 14/219,147

(22) Filed: Mar. 19, 2014

(51) Int. Cl. G01V 3/08; G01V 3/38

(52) U.S. Cl. CPC G01V 3/08; G01V 3/38

(57) ABSTRACT

The invention provides system for controlling two or more geo-physical scanners. The system includes a control unit that accepts inputs from a user. The control unit transmits control signals to the two or more geo-physical scanners based on the inputs from the user. Additionally, the control unit collects data from the two or more geo-physical scanners and the collected data is displayed to the user.

### FIELD OF THE INVENTION

The invention generally relates to integrating and controlling geo-physical scanners. More specifically, the invention relates to a control unit for controlling different types of geo-physical scanners while eliminating interference among the geo-physical scanners.

### BACKGROUND OF THE INVENTION

Geophysics is one of the most interesting sciences. Discovering earth is as ambiguous as discovering space. Many companies and research centers have developed systems and scanners capable of discovering what lies underneath. Most of those systems operate by emitting some type of electromagnetic signals/pulses, detecting the reflected signals, analyzing electromagnetic signals/pulses and finally imaging the subsurface structures. Such imaging of subsurface structures is performed using geo-physical scanners.

The main problem with the geo-physical scanners is that the scanning process is a time consuming process because scanning a specific geographic area of land may require usage of different types of geo-physical scanners. Typically, there is a lot of interference between different kinds of geo-physical scanners when used concurrently to obtain different readings for the specific geographic area of land. Due to the interference, performing concurrent scans using different types of geo-physical scanners is difficult.

Additionally, different human operators are required for operating the different types of geo-physical scanners. Each geo-physical scanner is operated by its own human operator. After finishing a geo-physical survey, the human operator is required to connect a geo-physical scanner to a host computer. Thereafter, the human operator is able to transfer the data collected by the geo-physical scanner to the host computer. Thus, each human operator for each geo-physical scanner conducts a geo-physical survey for the particular piece of land independently and transfers data to the host computer independently. This is time consuming and labor intensive.

Thus, there is a need to develop a method and system for efficiently controlling different types of geo-physical scanners.

### BRIEF DESCRIPTION OF THE FIGURES

The accompanying figures together with the detailed description below forms part of the specification and serves to further illustrate various embodiments and to explain various principles and advantages all in accordance with the invention.

FIG. 1 illustrates a simplified diagram of a system for controlling two or more geo-physical scanners in accordance with an embodiment of the invention.

FIG. 2 illustrates a block diagram of a control unit configured to control two or more geo-physical scanners in accordance with an embodiment of the invention.

FIG. 3 illustrates an exemplary circuit layout of the control unit in accordance with another embodiment of the invention.

FIG. 4 illustrates a cart configured to enable control of two or more geo-physical scanners in accordance with an embodiment of the invention.

FIG. 5 illustrates a flow diagram of a method of controlling two or more geo-physical scanners in accordance with an embodiment of the invention.

### DETAILED DESCRIPTION OF THE INVENTION

Before describing in detail embodiments that are in accordance with the invention, it should be observed that the embodiments reside primarily in a method and system for controlling two or more geo-physical scanners. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Generally speaking, pursuant to various embodiments, the invention provides a method and system for controlling two or more geo-physical scanners. The system includes a control unit for controlling two or more geo-physical scanners. In accordance with various embodiments, the control unit comprises a communicator, which is connected to the two or more geo-physical scanners. Further, the communicator is configured to transmit at least one control signal for controlling at least one geo-physical scanner of the two or more geo-physical scanners. The at least one control signal can be generated in response to receiving a user input. The communicator is also configured to collect data from the at least one geo-physical scanner in response to controlling the at least one geo-physical scanner based on the at least one control signal. The control unit also includes a processor connected to the communicator, wherein the processor is configured to process the data received from the at least one geo-physical scanner to generate an output.

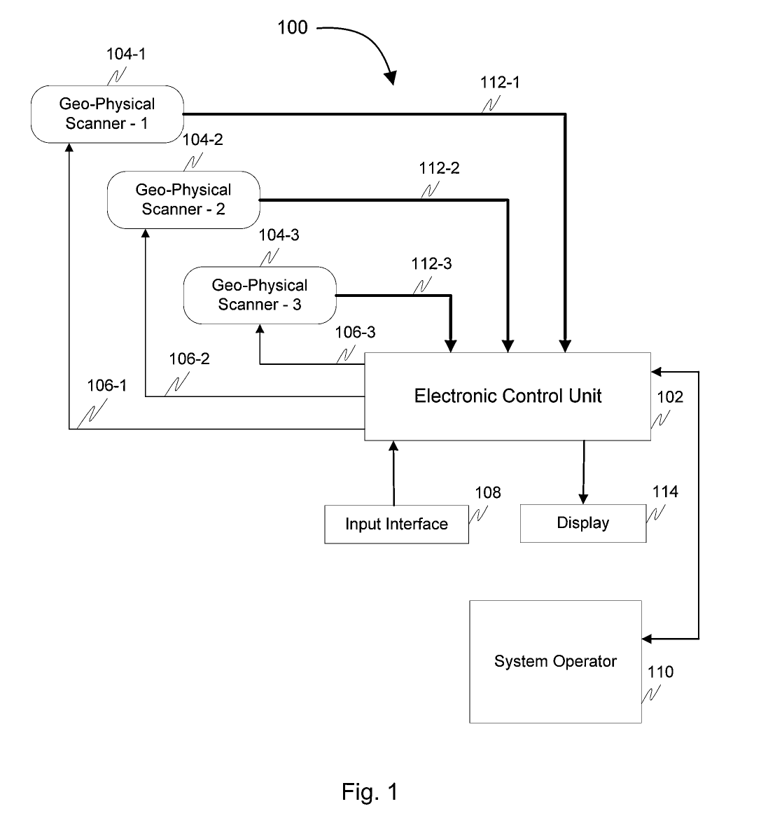

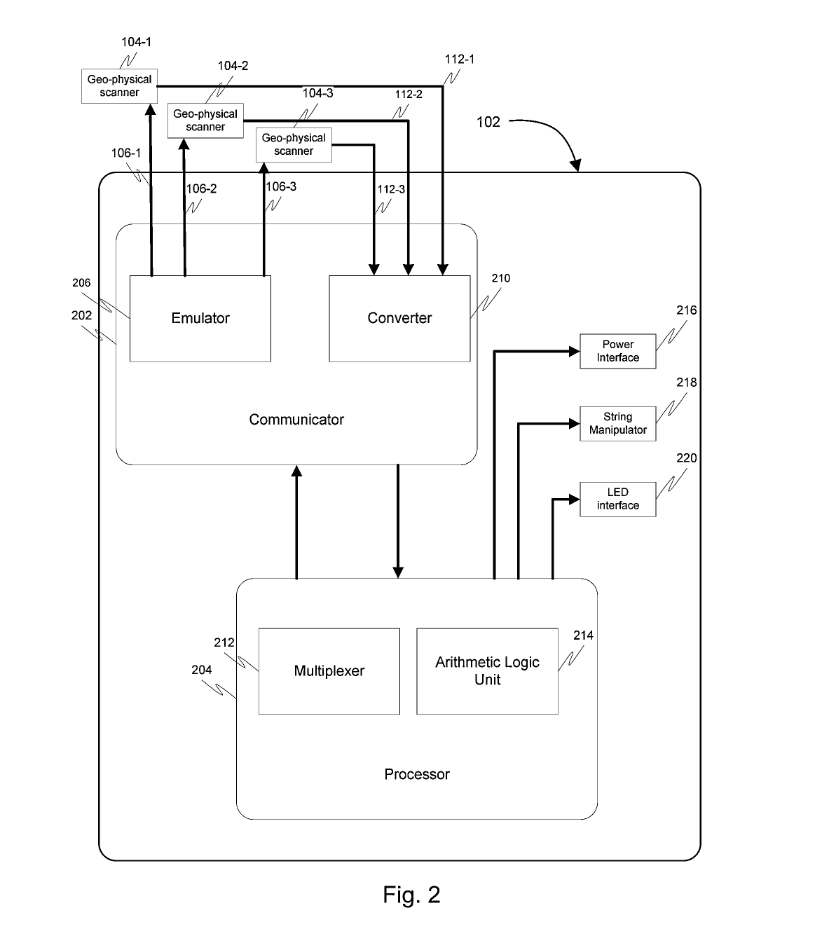

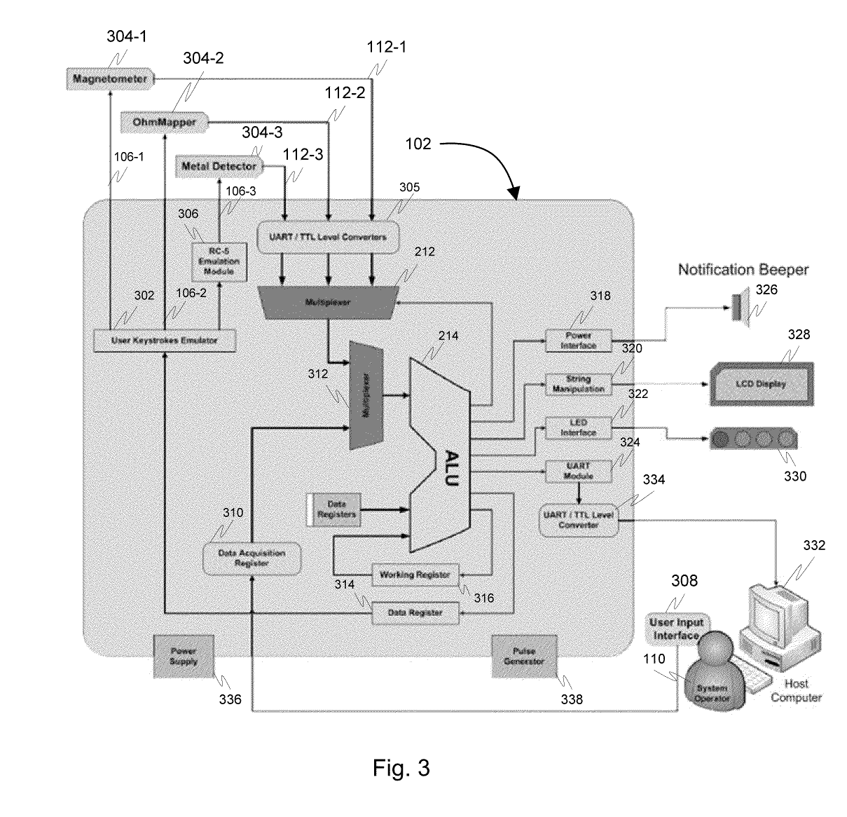

FIG. 1 illustrates a simplified diagram of a system 100 for controlling two or more geo-physical scanners 104-n in accordance with an embodiment of the invention. As shown in FIG. 1, system 100 includes a control unit 102 (described in detail in conjunction with description of FIG. 2 and FIG. 3) configured to control two or more geo-physical scanners 104-n such as, but not limited to, a geo-physical scanner 104-1, a geo-physical scanner 104-2 and a geo-physical scanner 104-3. In accordance with an embodiment, geo-physical scanner 104-1 is a magnetometer, geo-physical scanner 104-2 is an ohm-mapper and geo-physical scanner 104-3 is a metal detector. The two or more geo-physical scanners 104-n can include identical scanners or different types of scanners. For example, the two or more geo-physical scanners 104-n can include two magnetometers or a magnetometer and an ohm-mapper. Further, the two or more geo-physical scanners 104-n can include any number of scanners such as, but not limited to, two, three, four or five geo-physical scanners.

As illustrated in in FIG. 1, control unit 102 is connected to two or geo-physical scanners 104-n though a plurality of control lines 106-n such as, but not limited to, a control line 106-1, a control line 106-2 and a control line 106-3. Here, geo-physical scanner 104-1 is connected to control unit 102 using control line 106-1, geo-physical scanner 104-2 is connected to control unit 102 using control line 106-2 and geo-physical scanner 104-3 is connected to electronic control unit 102 using control line 106-3. Control unit 102 is configured to transmit one or more control signals to two or geo-physical scanners 104-n using one or more of the plurality of control lines 106-n. In accordance with various embodiments, the one or more control signals can be signals for controlling operation of the two or more geo-physical scanners. For instance, the control signals can be to cause the geo-physical scanners to scan a particular area. Alternately, the control signals can be to set operating parameters of the geo-physical scanners.

The one or more control signals can be transmitted based on an input received from a user. The input from the user can be obtained from an input interface 108 connected to control unit 102. The one or more control signals can alternately be input via a system operator 110 connected to electronic control unit 102. System operator 110 may include a host computer which enables the user to input the one or more control signals to control operations of the two or geo-physical scanners 104-n.

The two or more geo-physical scanners 104-n are configured to scan a geographic area based on the one or more control signals. The two or more geo-physical scanners are also configured to output data corresponding to the scan to control unit 102 via a plurality of data lines 112-n such as, but not limited to, a data line 112-1, a data line 112-2 and a data line 112-3.

A display 114 is connected to control unit 102. Display 114 can be an independent display or part of system operator 110. Further, display 114 is configured to enable control of the two or more geo-physical scanners 104-n by displaying data corresponding to control of the two or more geo-physical scanners. For example, display 114 can be configured to display different operations to receive input from the user. Alternately, display 114 can be configured to display the output obtained from two or more geo-physical scanners 104-n.

FIG. 2 illustrates a block diagram of a control unit 102 configured to control two or more geo-physical scanners 104-n in accordance with an embodiment of the invention. As shown in FIG. 2, control unit 102 includes a communicator 202 and a processor 204.

In accordance with the embodiment, control unit 102 is connected to the two or more geo-physical scanners 104-n, such a geo-physical scanner 104-1, a geo-physical scanner 104-2 and a geo-physical scanner 104-3 through communicator 202.

As illustrated, communicator 202 includes an emulator 206. In accordance with the embodiment, emulator 206 is configured to transmit one or more control signals using one or more of a plurality of control lines 106-n to one or more of the two or more geo-physical scanners 104-n for controlling operation of the corresponding geo-physical scanners. For example, communicator 202 may transmit signals for controlling a magnetometer. Taking another example, communicator 202 may transmit signals for controlling a magnetometer and an ohm-mapper. Taking yet another example, communicator may transmit signals for controlling a magnetometer, an ohm-mapper and a metal detector. Emulator 206 maybe one of, but not limited to, a user keystrokes emulator, a Universal Asynchronous Receiver/Transmitter (UART) interface module, and a RC-5 emulation module. The RC-5 Emulation Module is a special serial data transmission interface that uses Manchester encoding developed for sending RC-5 bit streams to emulate keystrokes on geo-physical scanner 104-3. The RC-5 Emulation Module requires corresponding software developed and installed on a corresponding geo-physical scanner such as geo-physical scanner 104-3.

Communicator 202 is configured to collect data from the corresponding geo-physical scanners in response to control of the corresponding geo-physical scanners. For example, communicator 202 is configured to receive scan data from a magnetometer in response to a scan signal sent to the magnetometer. The data is collected via one or more of a plurality of data lines 112-n such as, but not limited to, a data line 112-1, a data line 112-2 and a data line 112-3. Additionally, communicator 202 includes a converter 210 configured to convert the data collected from the corresponding geo-physical scanners. Converter 210 can be selected from a group consisting of, but not limited to, a Universal Asynchronous Receiver/Transmitter (UART) converter, a RC-5 converter and a keyboard strokes emulation converter. The UART converter is a serial protocol level converter used to convert TTL signals to RS232 signals and vice versa. The serial protocol level converters allows transmission and reception of signals serially from geo-physical scanners 104-n.

As illustrated in FIG. 2, control unit 102 also includes a processor 204 connected to communicator 202. Processor 204 is configured to process the data collected from two or more geo-physical scanners 104-n. In accordance with the embodiment illustrated in FIG. 2, processor 204 includes a multiplexer 212 configured to multiplex data received from two or more geo-physical scanner 104-n and the user. Multiplexer 212 is configured to select which input data provided by two or more geo-physical scanners 104-n should be fed to an arithmetic logic unit (ALU) 214. ALU 214 is connected to multiplexer 212 and is configured to process data received from multiplexer 212. The processing of data includes processing all calculations and logical operations related to the data. Additionally, processor 204 includes data acquisition registers, data registers and working registers (not illustrated in FIG. 2). The data acquisition registers are configured to store values obtained during user input. The data registers are also configured to store variables and constants which are later fetched and processed by ALU 214. The working registers store intermediate operation results performed by ALU 214 before re-processing.

Optionally, control unit 102 may include a power interface 216, a string manipulator 218 and an LED interface 220. Power Interface 216 is configured to amplify data generated by ALU 214. The amplification of data increases power of signals generated by ALU 214 before being interfaced to other components of control unit 102. String manipulator 218 is configured to convert output generated by processor 204 to characters. This can help in displaying the characters on a LCD display. LED interface 220 is configured to generate a visual notification in response to controlling of two or more geo-physical scanners 104-n.

Control unit 102 can also be connected to a power supply module (not illustrated in FIG. 2). The power supply module can be configured to provide one of regulated Direct Current (DC) and Alternating Current (AC). Additionally, control unit 102 can be connected to a pulse generator (not illustrated in FIG. 2), wherein the pulse generator is configured to provide input signals to processor 204 to operate.

Control unit 102 can also be connected to a notification beeper (not illustrated in FIG. 2), wherein the notification beeper is configured to generate audible sounds. Additionally, a display such as display 114 (refer FIG. 1) can be connected to control unit 102. The display can display instructions to an operator of two or more geo-physical scanner 104-n. The display can also display output generated from two or more geo-physical scanners 104-n. A set of LEDs (not illustrated in FIG. 2) can also be attached to control unit 102 to indicate various functions associated with functioning of two or more geo-physical scanners 104-n.

Control unit 102 can also be connected to a host computer such as system operator 110 using serial connectors. The data collected by control unit 102 from two or more geo-physical scanners 104-n can be transferred to the host computer via the serial connectors. A set of buttons and switches can be mounted on control unit 102 to enable a user to control operations of two or more geo-physical scanners 104-n.

FIG. 3 illustrates an exemplary circuit layout of control unit 102 in accordance with an embodiment of the invention. As shown in FIG. 3, control unit 102 includes a user keystrokes emulator 302 and a UART/TTL level converter 305. User keystrokes emulator 302 is configured to connect control unit 102 to two or more geo-physical scanners 304-n. In accordance with the embodiment, two or more geo-physical scanners 304-n includes a magnetometer 304-1, an ohmmapper 304-2 and a metal detector 304-3. Additionally, user keystrokes emulator 302 is configured for transmitting one or more control signals to one or more of magnetometer 304-1, ohmmapper 304-2 and metal detector 304-3. The one or more control signals are transmitted to two or more geo-physical scanners 304-n using a plurality of control lines 106-n such as, but not limited to, a control line 106-1, a control line 106-2 and a control line 106-3. In addition to user keystrokes emulator 302, an RC-5 emulation module 306 is placed in between metal detector 304-3 and user keystrokes emulator 302. RC-5 emulation module 306 is configured to provide serial data transmission that uses Manchester encoding and send RC-5 bit streams to emulate keystrokes on metal detector 304-3.

The one or more control signals that are transmitted are generated in response to an input provided by a user using a user input interface 308. User input interface 308 may be a set of buttons and switches mounted on top of control unit 102 to facilitate a user to control operations of two or more geo-physical scanners 304-n. Further, electronic control unit 102 includes a data acquisition register 310 that is configured to hold values obtained from user input interface 308. The user input obtained from user input interface 308, is provided to a multiplexer 312 of electronic control unit 102 using data acquisition register 310. Multiplexer 312 is configured to provide user input from data acquisition register 310 to an Arithmetic Logic Unit ALU 214 wherein ALU 214 is configured to process the user input. The user input is processed to identify at least one geo-physical scanner of two or more geo-physical scanners 304-n to which the one or more control signals should be transmitted to. The one or more control signals are transmitted using a data register 314 contained in ALU 214. Data register 314 is configured to store variables and constants which are later fetched and processed by ALU 214. Additionally, ALU 214 includes a working register 316 that is configured to store results of intermediate calculations performed by ALU 214.

Based on the user input, each geo-physical scanner of two or more geo-physical scanners 304-n provides data related to a specific land area. For example, magnetometer 304-1 obtains data regarding the specific land area in a first format, ohmmapper 304-2 obtains data regarding the specific land area in a second format and metal-detector 304-3 obtains data regarding the specific land area in a third format. The data is collected using a plurality of data lines 112-n such as, but not limited to, a data line 112-1, a data line 112-2 and a data line 112-3. The data is collected from plurality of data lines 112-n using Universal Asynchronous Receiver/Transmitter (UART)/Transistor-Transistor Logic (TTL) level converter 305. UART/TTL level converter 305 is configured to convert TTL level signals to RS232 level signals.

Additionally, control unit 102 includes a power interface 318, a string manipulator 320, an LED interface 322 and a UART module 324. Power Interface 318 is configured to amplify data generated by ALU 214. The amplification of data increases power of signals generated by ALU 214 before being interfaced to other components of control unit 102. Further, power interface 318 is electrically connected to a notification beeper 326 that is configured to generate audible sounds. Additionally, string manipulator 320 is configured to convert output generated by ALU 214 to characters. This helps in displaying the characters on a LCD display 328. Further, LED interface 322 is configured to generate a visual notification in response to controlling of two or more geo-physical scanners 304-n. The notification is provided using an array of lights 330 as shown in FIG. 3. As shown, UART module 324 of control unit 102 is configured to obtain data collected by plurality of data lines 112-n and transmit the data to a host computer 332 using a UART/TTL level converter 334. Host computer 332 is configured to display the data collected from two-or more geo-physical scanners 304-n. An operator 110 may monitor the data displayed on host computer 332.

In the embodiment illustrated in FIG. 3, control unit 102 is connected to a power supply module 336 configured to provide regulated +5V Direct Current (DC). Additionally, control unit 102 is connected to a pulse generator 338 configured to provide input signals to a processor 204 to operate.

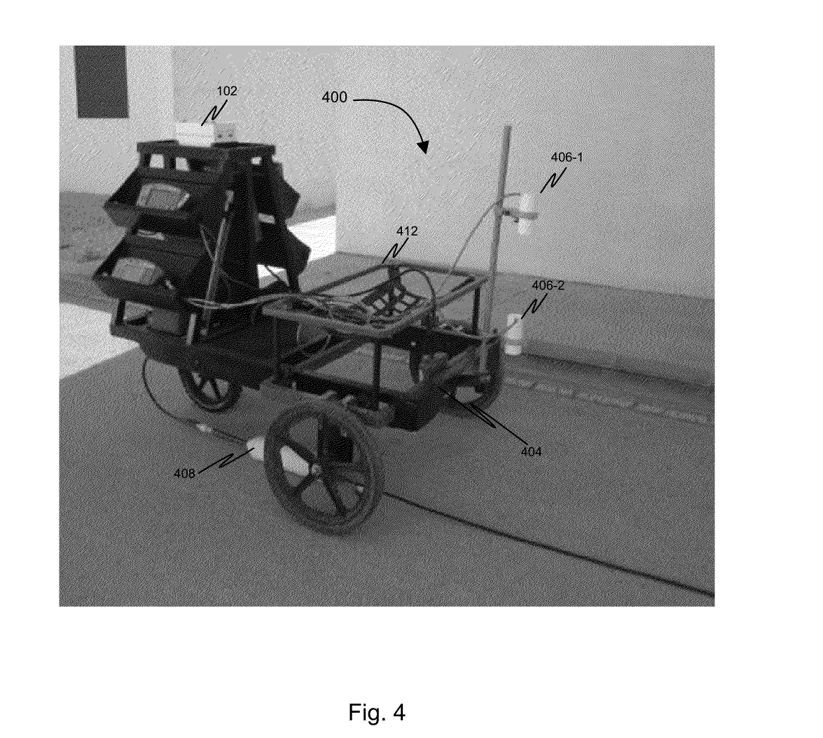

FIG. 4 illustrates a schematic diagram of a cart 400 configured to enable control of two or more geo-physical scanners. As illustrated, cart 400 includes a frame and a plurality of wheels attached to the frame. The frame can include a substantially rectangular base such as a base 404 and a plurality of shelves mounted on the substantially rectangular base. The two or more geo-physical scanners or components of the two or more geo-physical scanners or control components such as input interfaces or displays can be placed on the plurality of shelves. For instance, control unit 102, consoles that enable control of the two or more geo-physical scanners, one or more the two or more geo-physical scanners etc. can be placed on the plurality of shelves.

In accordance with the embodiment, cart 400 is designed such that the interference between the two or more geo-physical scanners is reduced. This is achieved by integrating a geo-physical scanner of the two or more geo-physical scanners with base 404. For instance, the metal detector can be integrated with base 404 as illustrated in FIG. 4 to reduce interference. Further, the sensors of the two or more geo-physical scanners are placed at a predetermined distance with respect to each other to reduce interference. In accordance with the embodiment, sensors 406-n such as a sensor 406-1 and a sensor 406-2 of magnetometer 304-1 are placed at a distance ranging from about 60 cms to 100 cms from the center of the metal detector loop assembly 412 as illustrated in FIG. 4. In addition, a sensor 408 of ohm-mapper 304-2 is placed at a distance of about 60 cms to 100 cms from sensors 406-n of magnetometer 304-1 of FIG. 4 to reduce interference. Sensors 406-n of magnetometer 304-1 are encapsulated inside an electromagnetic field in order to reduce magnetic field generated by the metal detector. Thus, by arranging the one or more sensors of two or more geo-physical sensors 304-n as described above, interference among two or more geo-physical sensors 304-n is reduced.

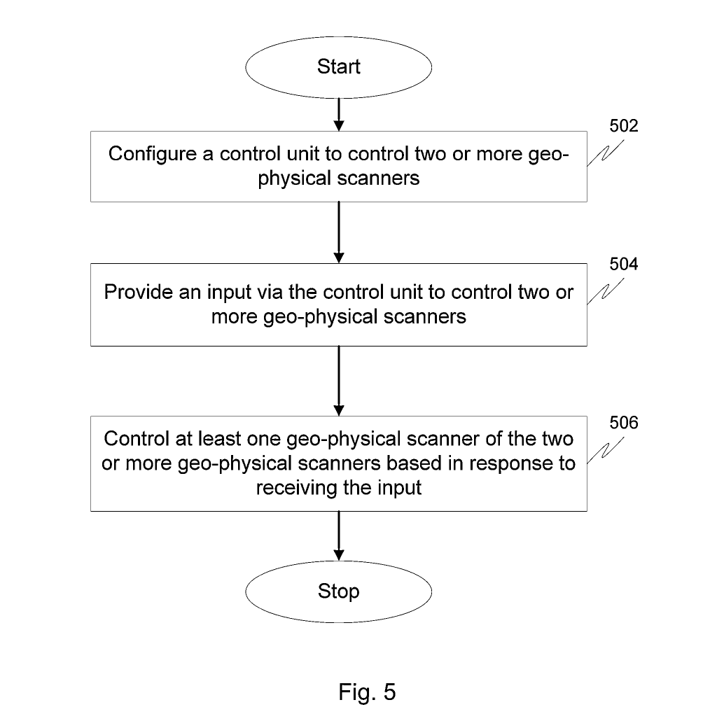

FIG. 5 illustrates a flow diagram of a method of controlling two or more geo-physical scanners in accordance with an embodiment of the invention.

At step 502, control unit 102 is configured to control two or more geo-physical scanners 104-n. The configuring of control unit 102 involves establishing a connection between control unit 102 and two or more geo-physical scanners 104-n. The connection is established using a communicator 202 that is part of control unit 102. This enables in establishing a communication mode between control unit 102 and two or more geo-physical scanners 104-n. In the communication mode, communicator 202 can transmit at least one control signal using a plurality of control lines and receive data from two or more geo-physical scanners 104-n using a plurality of data lines.

Moving on to step 504, an input to control two or more geo-physical scanners 104-n is provided via control unit 102. The input is provided by a user. The at least one control signal is transmitted based on input received from the user. The input is provided via an input interface of control unit 102. For instance a set of buttons and switches mounted on control unit 102 can be used to provide input. At step 506, two or more geo-physical scanners 104-n are controlled based on the input received by the user. Based on the input from the user, data is collected by communicator 202 using the plurality of data lines. The data is fed to a processor 204 that is a part of control unit 102. Processor 204 processes the data using an Arithmetic Logic Unit (ALU). The processed data is displayed as an output using a display interface.

In an exemplary implementation, three geo-physical scanners such as a magnetometer, an ohmmeter and a metal detector are placed in a cart. The cart is moved along a specific geographic piece of land to scan the specific geographic piece of land using the three geo-physical scanners. The specific geographic area of land is marked as parallel lines and predefined points are marked on the parallel lines. The three geo-physical scanners are connected to a control unit which is also placed in the cart. The control unit is configured to accept inputs from a user to control operations of the three geo-physical scanners. The inputs of the user are provided to the three geo-physical scanners using control lines. The control lines connect the three geo-physical scanners to the control unit.

The scanning of the geographical piece of land is performed by moving the cart along the predefined points. The input of the user enables at least one of the geo-physical scanners to operate in scan mode. The user presses a key on the control unit to initiate scanning and presses another key to stop scanning. For example, the user presses a key on the control unit to initiate scanning of the geographic piece of land using the magnetometer. The cart moves along the predefined points on the geographic piece of land to capture data. After moving the cart along the predefined points, the user presses another key to stop scanning. In an alternative embodiment, the user may press keys which are provided on at least one of the three geo-physical scanners to initiate scanning and end scanning. For example, a key may be placed on the magnetometer to initiate scanning and another key placed on the magnetometer may end scanning.

Data related to the scanning of the geographical piece of land is extracted from the three geo-physical scanners and transferred to the control unit. The data is transferred using data lines. The control unit in turn transfers the data to a computer for further analysis.

Various embodiments of the invention provide a method and system for controlling two or more geo-physical scanners. The method and system enables a user to simultaneously control the two or more geo-physical scanners remotely by employing a single control unit. Thus, the method and system eliminates the requirement of separate personnel for controlling different geo-physical scanners. Further, utilizing a cart design to support different sensors of the two or more geo-physical scanners enables in reducing interference caused during simultaneous use of the two or more geo-physical scanners.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A control unit for controlling two or more geo-physical scanners, the control unit comprising:
a communicator connected to the two or more geo-physical scanners, wherein the communicator is configured to:
transmit at least one control signal for controlling at least one geo-physical scanner of the two or more geo-physical scanners, wherein the at least one control signal is generated in response to receiving a user input; and
collect data from the at least one geo-physical scanner in response to controlling the at least one geo-physical scanner based on the at least one control signal; and
a processor connected to the communicator, wherein the processor is configured to process the data received from the at least one geo-physical scanner to generate an output.

2. The control unit of claim 1, wherein the communicator comprises:
a converter configured to convert the data collected from the at least one geo-physical scanner; and
an emulator configured to generate the at least one control signal in response to the user input.

3. The control unit of claim 2, wherein the converter is selected from a group consisting of a Universal Asynchronous Receiver/Transmitter (UART) converter, a RC-5 converter and a keyboard strokes emulation converter.

4. The control unit of claim 2, wherein the converter is connected to the two or more geo-physical scanners via two or more data lines, wherein the converter is configured to collect the data from the at least one geo-physical scanner via at least one data line of the two or more data lines.

5. The control unit of claim 2, wherein the emulator is connected to the two or more geo-physical scanners via two or more control lines, wherein the emulator is configured to transmit the at least one control signal to the at least one geo-physical scanner via at least one control line of the two or more control lines.

6. The control unit of claim 1, wherein the processor further comprises:
at least one multiplexer connected to the communicator, wherein the at least one multiplexer is configured to multiplex data received from at least one of the at least one geo-physical scanner and a user; and
an Arithmetic Logic Unit (ALU) connected to the at least one multiplexer, wherein the ALU is configured to process the data received from the at least one multiplexer.

7. The control unit of claim 6 further comprising:
a power interface configured to amplify data generated by the ALU;
a string manipulator configured to process the output generated by the processor to generate a display corresponding to the output; and
an LED interface configured to generate a notification in response to controlling of the at least one geo-physical scanner.

8. The control unit of claim 1 further comprising a user interface, wherein the user interface is configured to:
receive the user input for controlling the at least one geo-physical scanner; and
display the output generated by the processor.

9. The control unit of claim 1, wherein the control unit is coupled to at least one of an input interface and a display for performing at least one of:
receiving the user input for controlling the at least one geo-physical scanner; and
displaying the output generated by the processor.

10. The control unit of claim 1, wherein the two or more geo-physical scanners comprises a magnetometer, an ohmmapper and a metal detector.

11. A system for controlling two or more geo-physical scanners, the system comprising,
two or more geo-physical scanners;
a control unit configured to control the two or more geo-physical scanners;
at least one control interface, wherein the at least one control interface comprises:
an input interface configured to receive input from a user for controlling at least one of the two or more geo-physical scanners; and
a display connected to the control unit wherein the display is configured to display:
the user input for controlling the at least one geo-physical scanner; and
data collected from the two or more geo-physical scanners in response to control of the two or more geo-physical scanners using the control unit.

12. The system of claim 11 further comprising a cart, wherein the cart comprises:
a frame;
the two or more geo-physical scanners attached to the frame;
the control unit attached to the frame; and
two or more wheels.

13. The system of claim 12, wherein the frame comprises:
a substantially rectangular base; and
a shelf attached to the substantially rectangular frame, wherein the shelf is configured to hold at least one of:
at least one of the two or more geo-physical scanners;
the control unit;
the at least one control interface; and
the display.

14. The system of claim 13, wherein the two or more geo-physical scanners comprises a metal detector, a magnetometer and an ohmmapper.

15. The system of claim 14 further comprising a metal detector loop assembly integrated with the substantially rectangular frame.

16. The system of claim 15, wherein one or more sensors of the magnetometer are placed at a distance of about 100 cm from the center of the metal detector loop assembly.

17. The system of claim 16, wherein a dummy weight of the ohmmapper is placed at a distance of about 60 cm to 100 cm from the one or more sensors of the magnetometer.

18. A method for controlling two or more geo-physical scanners, the method comprising:
configuring a control unit for controlling the two or more geo-physical scanners, wherein configuring the control unit comprises:
establishing a connection between the control unit and the two or more geo-physical scanners; and
establishing a communication mode between the control unit and the two or more geo-physical scanners;
providing an input via the control unit for controlling at least one of the two or more geo-physical scanners; and
controlling the at least one geo-physical scanner using the control unit in response to receiving the input.
